(19) United States
(12) Patent Application Publication
(10) Pub. No.: US 2024/0036927 A1
(43) Pub. Date: Feb. 1, 2024

(54) METHOD FOR PROCESSING WORKFLOW IN COMBINATION WITH TASK, TASK PROCESSING METHOD, AND RELATED DEVICE

(71) Applicant: Beijing Zitiao Network Technology Co., Ltd., Beijing (CN)

(72) Inventors: Jiangfeng MA, Beijing (CN); Wei HUANG, Beijing (CN); Xinlei GUO, Beijing (CN); Qi WEN, Beijing (CN); Shengxin QIU, Beijing (CN)

(21) Appl. No.: 18/356,804

(22) Filed: Jul. 21, 2023

(30) Foreign Application Priority Data
Jul. 27, 2022 (CN) 202210895062.8

(51) Int. Cl. G06F 9/50

(52) U.S. Cl. CPC G06F 9/5027

(57) ABSTRACT

A method for processing a workflow in combination with a task, a task processing method, and related devices are provided. During reporting the workflow, a task control is created in a preset area, in response to a task addition instruction. A target task to be added may be inserted into the task control for display. In this way, the workflow added with the target task can be reported to a target user.

This application claims the priority to Chinese Patent Application No. 202210895062.8, titled “METHOD FOR PROCESSING WORKFLOW IN COMBINATION WITH TASK, TASK PROCESSING METHOD, AND RELATED DEVICES”, filed on Jul. 27, 2022 with the China National Intellectual Property Administration (CNIPA), which is incorporated herein by reference in its entirety.

### FIELD

The present disclosure relates to the technical field of event management, and in particular to a method for processing a workflow in combination with a task, a task processing method, and a related device.

### BACKGROUND

Some enterprises or organizations regularly ask staff to report workflows, and the enterprises or organizations may set up tasks.

However, in the conventional technology, workflow reporting and task management are two independent processes. Data in the two processes cannot be interchanged. Therefore, bilateral maintenance is required, which reduces the efficiency of work management and affects the utilization effect.

### SUMMARY

In view of this, a method for processing a workflow in combination with a task, a task processing method, and a related device are provided according to the present disclosure, to completely or partially solve the above technical problems.

Based on the above objective, a method for processing a workflow in combination with a task is provided in a first aspect of the present disclosure. The method includes: displaying a task page on a content editing interface, in response to receiving a task addition instruction on the content editing interface for the workflow; selecting a target task from a task displayed on the task page; creating a task control in a preset area of the content editing interface, and displaying the target task in the task control; and sending the workflow added with the target task to a target user.

Based on the same concept, a task processing method is provided in a second aspect of the present disclosure. The method includes: determining whether task associated information for a target task is added in a workflow, in response to sending the workflow added with the target task to a target user; and synchronizing the task associated information to a task system corresponding to the target task, in a case of determining that the task associated information for the target task is added in the workflow.

Based on the same concept, an apparatus for processing a workflow in combination with a task is provided in a third aspect of the present disclosure. The apparatus includes a task page display module, a task determination module, a task control creation module, and a sending module. The task page display module is configured to display a task page on a content editing interface, in response to receiving a task addition instruction on the content editing interface for the workflow. The task determination module is configured to select a target task from a task displayed on the task page. The task control creation module is configured to create a task control in a preset area of the content editing interface and display the target task in the task control. The sending module is configured to send the workflow added with the target task to the target user.

Based on the same concept, a task processing apparatus is provided in a fourth aspect of the present disclosure. The apparatus includes a task receiving module and a task synchronization module. The task receiving module is configured to determine whether task associated information for a target task is added in a workflow, in response to sending the workflow added with the target task to a target user. The task synchronization module is configured to synchronize the task associated information to a task system corresponding to the target task, in a case of determining that the task associated information for the target task is added in the workflow.

Based on the same concept, an electronic device is provided in a fifth aspect of the present disclosure. The electronic device includes a memory, a processor, and a computer program stored in the memory and executable by the processor. The processor, when executing the program, implements the method according to the first aspect or the second aspect.

Based on the same concept, a non-transitory computer-readable storage medium is provided in a sixth aspect of the present disclosure. The non-transient computer-readable storage medium stores computer instructions for enabling a computer to implement the method according to the first aspect or the second aspect.

Based on the above, with the method for processing the workflow in combination with the task, the task processing method and related devices according to the present disclosure, the task control is created at the preset area in response to the task addition instruction, in a process of reporting the workflow. The target task to be added may be inserted into the task control for display. In this way, the workflow added with the target task can be reported to the target user. Moreover, in the case that task associated information for the target task is added, the task associated information may be synchronized to the task system, so that data interaction may be performed between the workflow and the task system. In addition, the data in the workflow and the data in the task system can be uploaded simultaneously without bilateral maintenance, improving the efficiency of work management and facilitating utilization.

### BRIEF DESCRIPTION OF THE DRAWINGS

In order to more clearly describe the technical solutions in the embodiments of the present disclosure or the technical solutions in the conventional technology, drawings to be used in the description of the embodiments of the present disclosure or the conventional technology are briefly described hereinafter. It is apparent that the drawings described below are merely used for describing the embodiments of the present disclosure, and those skilled in the art may obtain other drawings according to the drawings without any creative effort.

FIG. 1 is a schematic diagram showing an application scenario according to an embodiment of the present disclosure;

FIG. 2 is a flowchart of a method for processing a workflow in combination with a task according to an embodiment of the present disclosure;

FIG. 3 is a flowchart of a task processing method according to an embodiment of the present disclosure;

FIG. 4A is a schematic diagram showing a display of a task interface for filling an event report according to an embodiment of the present disclosure;

FIG. 4B is a schematic diagram showing a display after an icon of a task addition control is triggered according to an embodiment of the present disclosure;

FIG. 4C is a schematic diagram showing a display after a task is checked according to an embodiment of the present disclosure;

FIG. 4D is a schematic diagram showing a display after a task is inserted according to an embodiment of the present disclosure;

FIG. 4E is a schematic diagram showing a display of adding task associated information to the inserted task according to an embodiment of the present disclosure;

FIG. 4F is a schematic diagram showing a display after an event report is submitted according to an embodiment of the present disclosure;

FIG. 4G is a schematic diagram showing a display of viewing task details according to an embodiment of the present disclosure;

FIG. 4H is a schematic diagram showing a display of submission failed due to the inserted task being deleted from a task system according to an embodiment of the present disclosure;

FIG. 5 is a structural block diagram of an apparatus for processing a workflow in combination with a task according to an embodiment of the present disclosure;

FIG. 6 is a structural block diagram of a task processing apparatus according to an embodiment of the present disclosure; and

FIG. 7 is a structural schematic diagram of an electronic device according to an embodiment of the present disclosure.

### DETAILED DESCRIPTION OF EMBODIMENTS

It can be understood that data (including but not limited to the data itself, acquisition or use of the data) involved in the technical solutions should comply with requirements of corresponding laws, regulations and relevant provisions.

The principles and spirit of the present disclosure are described below with reference to exemplary embodiments. It should be understood that these embodiments are provided only to enable those skilled in the art to better understand and implement the present disclosure, and not to limit the scope of the present disclosure in any way. In addition, these embodiments are provided to make the present disclosure more thorough and complete, and to fully convey the scope of the present disclosure to those skilled in the art.

It can be understood that, the user is informed of a type, an application range and an application scenario of personal information in an appropriate manner, to obtain permission from the user before the technical solutions of the embodiments of the present disclosure are used.

For example, prompt information is sent to the user in response to a reception of an active request from the user, to explicitly inform the user that the requested operation may acquire and use personal information of the user. Therefore, the user may voluntarily determine, according to the prompt information, whether to provide the personal information to software or hardware, such as an electronic device, an application, a server, or a storage medium, with which an operation is performed according to the technical solutions of the present disclosure.

As an optional but non-restrictive implementation, the prompt information is sent to the user in response to the reception of the active request from the user with a pop-up window, for example. The prompt information may be presented as a text in the pop-up window. In addition, a selection control may also be provided in the pop-up window, by which the user may select “agree” or “disagree” to provide personal information to the electronic device.

It can be understood that the above process of informing the user and obtaining permission from the user is only illustrative, and the implementation of the present disclosure is does not limited thereto. Other implementations that conform to the relevant laws and regulations may also be applied to the present disclosure.

In the present disclosure, it should be noted that the number of elements in the drawings is only illustrative but not limitative, and names are only used to distinguish one element from another without any limitation.

The principles and the spirit of the present disclosure are explained in detail below with reference to representative embodiments of the present disclosure.

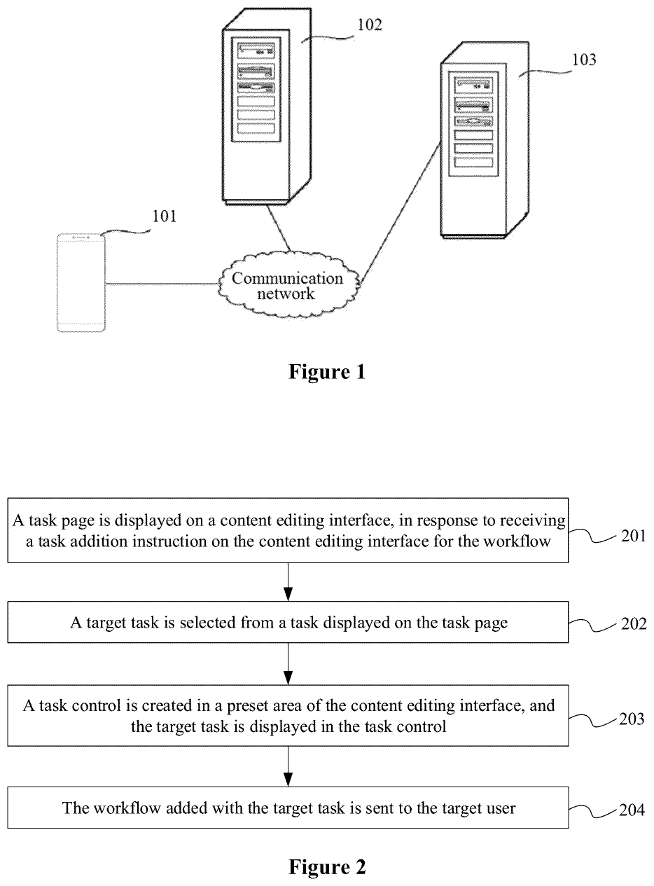

Reference is made to FIG. 1, which is a schematic diagram showing an application scenario of a method for processing a workflow in combination with a task and a task processing method according to an embodiment of the present disclosure. The application scenario includes a terminal device 101, a server 102, and a data storage system 103. The terminal device 101, the server 102, and the data storage system 103 may be connected to each other through a wired or wireless communication network. The terminal device 101 includes but is not limited to a desktop computer, a mobile phone, a mobile computer, a tablet, a media player, a smart wearable device, a personal digital assistant (PDA), or other electronic devices capable of realizing the above functions. The server 102 and the data storage system 103 each may be an independent physical server. Alternatively, the server 102 and the data storage system 103 each may be a server cluster or a distributed system including multiple physical servers. Alternatively, the server 102 and the data storage system 103 each may be a cloud server providing a basic cloud computing service such as a cloud service, a cloud database, cloud computing, a cloud function, cloud storage, a network service, cloud communications, a middleware service, a domain name service, a security service, CDN, and a big data and artificial intelligence platform.

A user fills in a workflow through the terminal device 101, and triggers a task addition control to generate a task addition instruction. The server 102 may send a task to a task page in a content editing interface for the workflow on the terminal device 101 for display. The user selects a target task through the terminal device 101, creates a task control at a preset area of the content editing interface, and adds the target task to the workflow. After the target task is added, the workflow added with the target task is reported to a target user through the server 102. In this way, the target user can know the reported workflow on a terminal device of the target user. The server 102 synchronizes task associated information of the target task in the workflow to a task system for recording. The data storage system 103 stores data required by operations of the server 102. The data, for example, may be executed program codes and data related to workflows of users and the task system.

A method for processing a workflow in combination with a task and a task processing method according to exemplary embodiments of the present disclosure are described below in combination with the application scenario shown in FIG. 1. It should be noted that, the above application scenario is shown only for facilitating understanding for the spirit and the scope of the present disclosure. The embodiments of the present disclosure are not limited to the application scenario. The embodiments of the present disclosure may be applied to any proper scenarios.

A method for processing a workflow in combination with a task is provided according to an embodiment of the present disclosure.

As shown in FIG. 2, the method includes the following steps 201 to 204.

In step 201, a task page is displayed on a content editing interface, in response to receiving a task addition instruction on the content editing interface for the workflow.

In some embodiments, the workflow may be a daily report, a weekly report, a monthly report, a quarterly report, an annual report, a final project report, or the like.

The content editing interface for the workflow is presented after the user triggers a control for filling in the workflow (for example, after the user clicks an icon through a mouse). The user may fill in content of the workflow on the content editing interface.

In some embodiments, the user may trigger an icon of a task addition control during or after filling in a to-be-reported task, to generate a task addition instruction. Then, a task corresponding to the user is called from a task system in response to the task addition instruction. A task page including the task is displayed on the content editing interface.

In some embodiments, the task addition instruction may be specific characters inputted when editing the content of the workflow. The task page is triggered and displayed through the characters. For example, the characters may be “/content” or “@content”. The content in the characters may be a name of a function, such as, a task.

In some embodiments, a process of generating the task addition instruction in step 201 may include: displaying a task addition control on the content editing interface for the workflow; and in response to trigger the task addition control, generating the task addition instruction in a case of determining that an account triggering the task addition control activates a task function; and generating prompt information for activating the task function in a case of determining that the account triggering the task addition control does not activate the task function.

In some embodiments, after the task addition control is triggered, identity information of the account triggering the task addition control may be acquired. It should be noted that the identity information is acquired on a premise of agreement of the user owning the account. It may be determined whether the task function is activated for the identity information. For example, an enterprise owning the identity information activates the task function for the identity information. Only an account activating the task function can generate the task addition instruction. When an account not activating the task function triggers the task addition control, the user is prompted to ask an enterprise owning the account to activate the task function.

In some embodiments, in the case that the account triggering the task addition control does not activate the task function, prompt information “the function is not activated yet, please activate the function before enabling” is sent after the task addition control is triggered. A link for activating the task function may be added to the prompt information, so that the user can activate the task function through the link.

In step 202, a target task is selected from a task displayed on the task page.

In some embodiments, step 202 includes the following steps 2021 and 2022.

In step 2021, at least one task corresponding to the task addition instruction is displayed on the task page.

In some embodiments, the task displayed on the task page includes a first subtask and/or a second subtask. Content of the second subtask is associated with content of the first subtask.

In some embodiments, each first subtask includes at least one second subtask. The first subtask and/or the second subtask are called from the task system in response to the task addition instruction.

In some embodiments, the terminal device acquires the identity information of the user corresponding to the task addition instruction and reports the identity information to the server. The server calls one or more tasks corresponding to the identity information from the task system, and sends the one or more tasks to the terminal device to display them on the task page.

In some embodiments, there are following cases in the process of displaying one or more tasks.

In the case A, the task function is activated, and no content is included in the task.

In the case B, the task function is activated, less content is included in the task, and all of the content can be displayed on the task page.

In the case C, the task function is activated, a lot of contents are included in the task, and the contents are displayed on the task page in a rolling manner.

In the case D, the task function is activated, the user's mouse hovers over a certain task on the task page. If the certain task has been added to the workflow, prompt information for prompting that the task has been added is displayed.

In the case E, the task function is activated, and a group of pieces of prompt information is generated after the user clicks the icon of the task addition control. For example, the prompt information may be “the task associated information will be automatically synchronized to the task system after submitted by the user”.

The one or more tasks may be displayed in a task cycle selected by the user, which is described as follows.

In some embodiments, step 2021 includes the following steps 20211 to 20213.

In step 20211, at least one task cycle corresponding to the task addition instruction is determined. The at least one task cycle is ranked in a chronological order, and is displayed on the task page. One task cycle corresponds to one time period.

In some embodiments, time periods corresponding to task cycles may be divided based on a task plan developed by the enterprise. For example, the time period may be one month as one task cycle or one quarter as one task cycle. One task plan corresponds to multiple task cycles. The multiple task cycles are ranked in a positive chronological order or a reverse chronological order. Preferably, the task cycles are ranked in the reverse chronological order. A current time may be acquired after the task cycles are ranked, and a task cycle corresponding to the current time in the ranked result is displayed preferentially.

In order to avoid confusion of task cycles, only one task cycle rather than multiple task cycles can be selected from the at least one task cycle each time.

In step 20212, a target task cycle selected from the at least one task cycle is received.

In some embodiments, the user may select one task cycle from the at least one task cycle as the target task cycle. If the user does not select a task cycle, the default is that the user does not activate the task function. Alternatively, if the user does not select a task cycle, the default is that the user selects the task cycle corresponding to the current time.

In step 20213, in response to determining that there is a task within the target task cycle, at least one task corresponding to the target task cycle is called and displayed on the task page.

In some embodiments, it is determined whether there is a task within the target task cycle. In the case that a task is determined within the target task cycle, all tasks with the target task cycle are displayed. In the case that no task is determined within the target task cycle, prompt information is displayed. For example, the prompt information may be “No task”.

In some embodiments, in the process of displaying one or more tasks, all first subtasks of the task within the target task cycle and one or more second subtasks corresponding to each of the first subtasks may be displayed. In an embodiment, the second subtask is displayed below the first subtask corresponding to the second subtask.

In step 2022, at least one target task selected from the at least one task is received.

In some embodiments, step 2022 includes the following steps 20221 and 20222.

In step 20221, the second subtask is set to be selectable, and the first subtask is set to be unselectable.

In step 20222, at least one target second subtask selected from the at least one second subtask is received, and the selected target second subtask is determined as the target task.

In some embodiments, the at least one target second subtask selected from the at least one second subtask by the user is received as the target task. Since the first subtask is unchangeable, it is required to set the first subtask to be unselectable and not insertable (only displayable) and to set the second subtask to be selectable and insertable. Multiple-choice may be performed on the second subtasks.

After a second subtask is selected, an insert button may be provided on the task page. For example, the insert button may be provided on a border of the task page. Specifically, the insert button may be arranged at any position of a top border, a bottom border, a left border or a right border of the task page. The “insert button” on the task page is highlighted and can be triggered after the user selects this task page. The “insert button” is grayed out and cannot be triggered in that case that the user does not select the task page. In this case, the user may click a position rather than the task page to return to the content editing interface for filling in the workflow.

In some embodiments, the target task is displayed in the task control by: determining a first identification of the second subtask corresponding to the target task, and a second identification of the first subtask corresponding to the target task; and displaying the first identification and the second identification in the task control.

In some embodiments, the displaying the first identification and the second identification in the task control includes: combining the first identification with the second identification, and displaying the combination of the first identification and the second identification in the task control.

The combination of the first identification and the second identification may be: the first identification plus the second identification, or the second identification plus the first identification.

In some embodiments, the second subtask selected by the user is inserted into the task control as the target task after the user clicks the “insert button”. In this way, the first identification, the second identification, and content information edited for the second subtask are displayed in the task control.

Prompt information is displayed on the task interface after the target task is inserted. The prompt information, for example, may be “the task associated information will be automatically synchronized to the task system after submission”. A window of the prompt information is provided with a close button. The user may click the close button to hide the prompt copy.

In step 203, a task control is created in a preset area of the content editing interface, and the target task is displayed in the task control.

In some embodiments, step 203 includes: creating the task control in a content editing area of the content editing interface. The content editing area is used for inputting at least one of a text, a picture, a video and an audio.

In some embodiments, the task control includes a task information display area and a task associated information editing area. The task information display area is used for displaying the target task. The task associated information editing area is used for editing content information associated with the target task.

In some embodiments, the target task is displayed in the task control by: displaying, in response to receiving an editing operation in the task associated information editing area of the task control, an editing result of the editing operation in the task associated information editing area.

In some embodiments, the user selects a target task to be filled in, from the selected target tasks. For example, the user clicks, with the hand or the mouse, the target task. After clicking, the user may input task associated information (for example, task progress information) corresponding to the target task in the task associated information editing area (for example, a rich text box) below the target task. Alternatively, the task progress information corresponding to the target task may be inputted in a text inputting box at the top of the content editing interface. The user may select a position for filling in information according to actual needs.

A state display control is provided in the task associated information editing area, which is configured to display a current state of the target task. The current state may include a normal state or an abnormal state. In the normal state, the user may fill in task associated information. In the abnormal state, the user cannot fill in the task associated information.

After the task progress information is filled in, each target task is provided with a delete icon at the top right of the target task. The user may trigger the deletion icon to delete the filled task progress information.

In step 204, the workflow added with the target task is sent to the target user.

In some embodiments, step 204 includes: generating prompt information for removing the deleted task, in response to a deleted task included in the added at least one target task.

In some embodiments, the content editing interface is provided with a submission control (for example, a submit button). The user triggers the submission control after confirming that the filled workflow, target tasks and task associated information for the target tasks are correct. In this case, the target tasks may be matched with the tasks in the task system. If a task is deleted from the task system and the deleted task corresponds to the target tasks obtained above, the workflow submission fails and the user is prompted to delete the target task. The user triggers the submission control once again after deleting the target task, to successfully submit the workflow. In a case that the tasks corresponding to all target tasks are included in the task system, the workflow is directly submitted successfully.

Successful submission refers to that the workflow with the target task is reported to the target user through the server and the reported workflow may be viewed by the target user, and that the workflow is reported to the task system to synchronously update the task associated information added by the user for the target task to the task system.

In this way, the user is required to submit the task only once without bilateral maintenance, which improves the efficiency of task reporting and user experience.

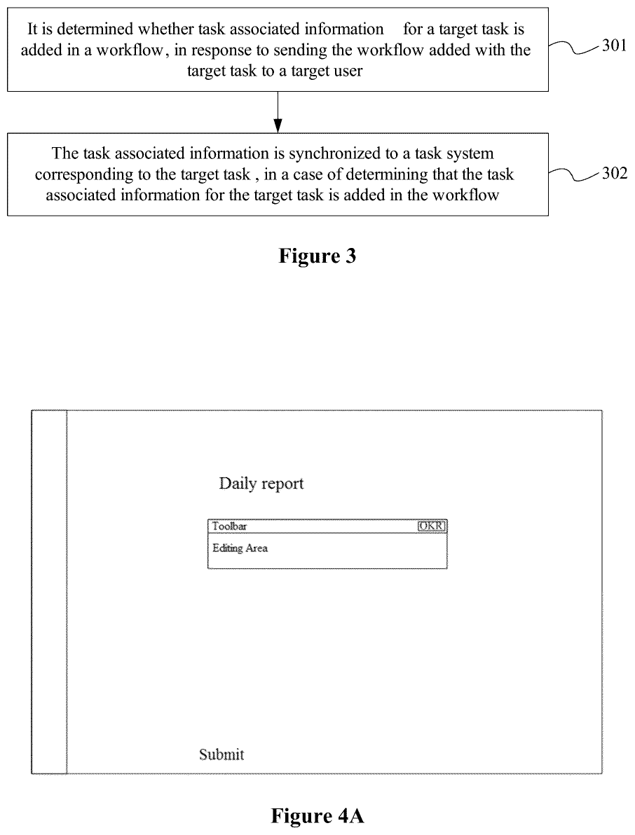

Based on the same concept, a task processing method is provided according to an embodiment of the present disclosure. The task processing method is applied to a task system side. As shown in FIG. 3, the task processing method includes the following steps 301 and 302.

In step 301, it is determined whether task associated information for a target task is added in a workflow, in response to sending the workflow added with the target task to a target user.

In step 302, the task associated information is synchronized to a task system corresponding to the target task, in a case of determining that the task associated information for the target task is added in the workflow.

In some embodiments, the user sends the workflow added with the target task to the target user through a server. The server forwards the workflow to the task system. In this way, the task associated information for the target task added to the workflow can be synchronously updated to the task system in time. In this way, the task associated information is synchronized to the task system when the workflow is submitted, without bilateral maintenance, which improves the efficiency of task management, thereby facilitating utilization.

In some embodiments, the task system includes at least one first subtask component and/or multiple second subtask components. Each of the at least one first subtask component is associated with at least one of the plurality of second subtask components.

Step 302 includes the following steps 3021 and 3022.

In step 3021, it is determined that at least one piece of task associated information is added for one second subtask component. The at least one piece of task associated information is sent through at least one account.

In step 3022, the at least one piece of task associated information is inserted into a task record corresponding to the same second subtask component, and source information corresponding to the at least one piece of task associated information is marked in the task record.

In some embodiments, in the task system, since task associated information cannot be added for the first subtask, the task associated information is only added for the second subtask in the target task. Therefore, it is only required to supplement the task associated information for the second subtask to the task record corresponding to the second subtask component. Alternatively, multiple pieces of task associated information from different users may be supplemented to the same second subtask component.

In order to determine source of task progress information, it is required to add a mark of source information behind each piece of task associated information in the task record. The source information includes at least one of: a user name, a submission time, and a name of an event report task. For example, a format of the source information is “synchronized from # template name (i.e. name of the workflow) # filled in # submitted at # year: month: day: hour: minute: second (submission time). The # template name # is clickable, and details of the workflow are opened by clicking the # template name #.

In some embodiments of the present disclosure, a process of sending a workflow and a process of synchronously updating the task associated information of the target task to the task system are described in detail in the same embodiment. In the description, the workflow is a report, and the task system is an Objectives and Key Results (OKR) task system. Detailed description is as follows.

In a first step, content of an event report is filled in and an OKR task is called.

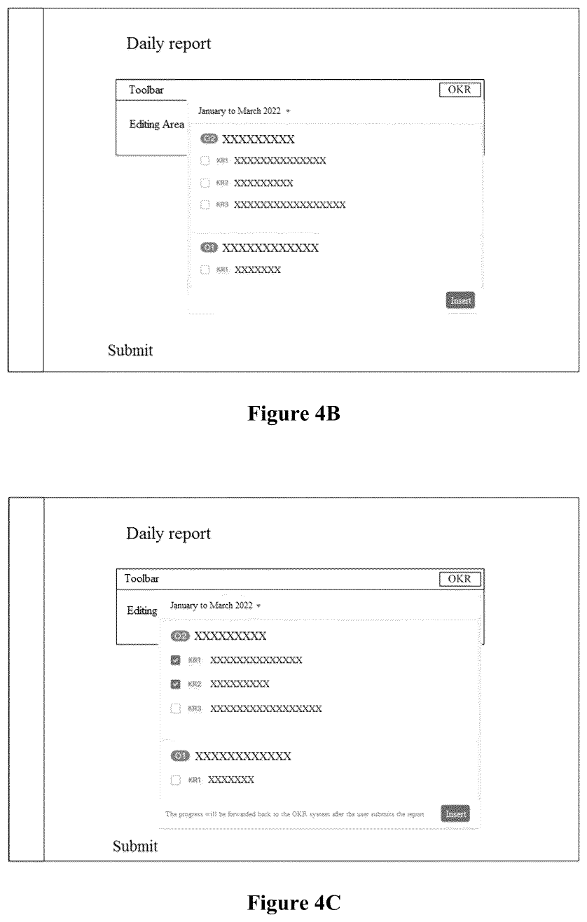

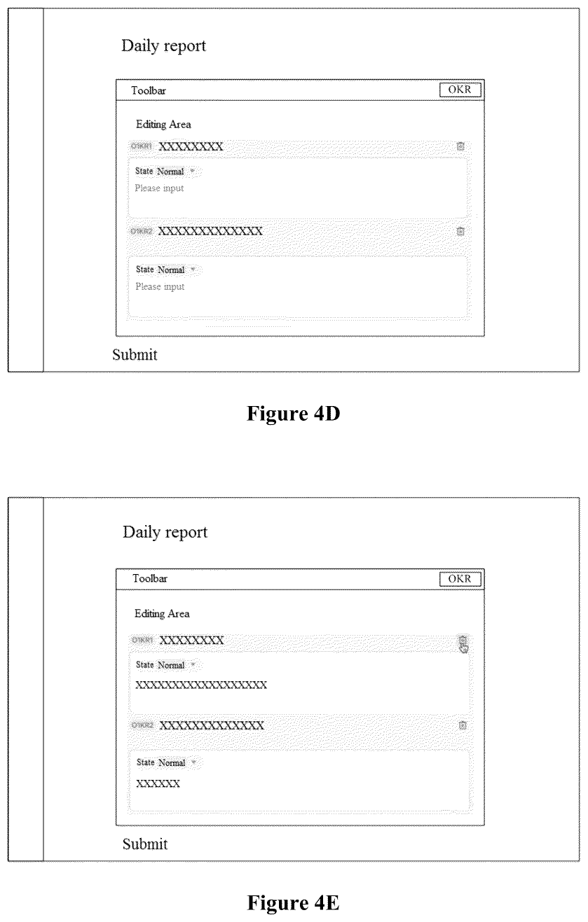

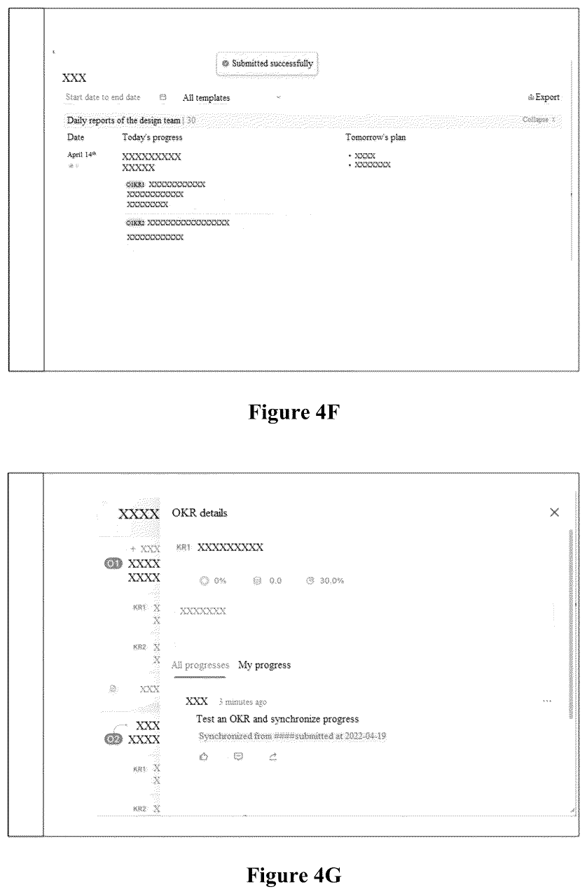

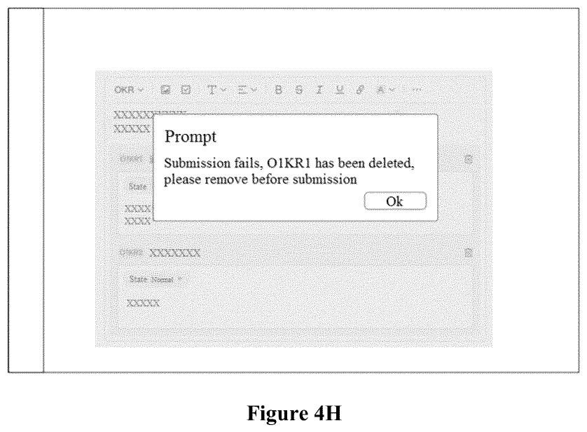

A toolbar of a text control (that is, a toolbar of a content editing interface) is provided with an “OKR” icon (that is, an icon of a task addition control, an “OKR” icon as shown in FIG. 4A). The “OKR” icon is clicked to call an “OKR” task. Details of the “OKR” task are displayed to the user, as shown in FIG. 4B.

First, an OKR cycle including a current date is displayed based on the current data. For example, in the case of a quarter OKR and the current date of Apr. 3, 2022, “April to June 2022” is displayed.

Second, configuration items for OKR cycles are acquired. The configuration items for the OKR cycles are switchable, and are arranged in a reverse chronological order. Only one configuration item for the OKR cycle can be selected.

Thirdly, if the user does not activate an OKR application, prompt information “your enterprise has not activate OKR yet” is generated after the “OKR” icon is clicked.

Fourthly, in the case that there is OKR within a cycle selected by the OKR system, full details of the cycle are displayed according to an OKR layout. One of details of the cycle may be checked and inserted in a customized manner (only KR is allowed to be inserted, and O is not allowed to be inserted). In the case that there is no OKR in the cycle, information “No OKR” is displayed.

There are several cases as follows.

In the case 1, a prompt copy “the progress will be automatically synchronized to the OKR system after submission of the report” is displayed at the top of the task page. It is allowed to close the copy, and the copy is hidden after the copy is closed.

In the case 2, multiple Key Results (KR) tasks are allowed to be selected. If there are few KRs, all KRs are displayed. If there are many KRs, the KRs are displayed in a rolling manner.

In the case 3, an inserted KR is grayed out and cannot be selected. When a mouse hovers over the inserted KR, a copy “the key result has been inserted” is displayed.

Fifthly, for the [insert] button, if there are checked KR details, the insert button is highlighted (the “insertion” button as shown in FIG. 4C). The insert button may be clicked to directly insert the selected details into a rich text box. If there is no checked KR detail, the insert button is grayed out and is not operable (for example, the “insert” button as shown in FIG. 4B).

In the second step, the OKR task is inserted and an OKR progress is filled in.

First, the OKR is inserted. O#N#KR#N# (O1KR1 and O2KR2 as shown in FIG. 4D) and content corresponding to the KR are displayed. For example, the content corresponding to the KR may be “O1KR1: a “review a report” modification scheme is completed, and a customer satisfaction≥90% after going online”.

Second, an area for filling in a “progress record” is a rich text box, as shown in FIG. 4D. The input may be performed by a toolbar at the top.

Thirdly, a “delete” icon is displayed on the right of the inserted detail of KR. For example, the “delete” icon may be a trashcan icon as shown in FIG. 4E. The “delete” icon may be clicked to directly remove the added task progress information.

In a third step, an event report is submitted. FIG. 4F shows a display interface after submission. The task progress information corresponding to the added OKR task is sent back to the OKR system.

A task record with the inserted OKR is automatically synchronized to the OKR system after submission of the report with the inserted OKR task. Reference is made to FIG. 4G, which shows a process of synchronous updating the task progress information to the OKR system.

First, synchronization is described as follows.
1. A piece of progress data including “progress record” is inserted into “my progress” under a corresponding KR, and a source of the progress data is displayed. As shown in FIG. 4G, “all progresses” or “my progress” may be displayed.

A format of the source is: “synchronized from # template name # filled in # submitted at yyyy-mm-dd hh:mm”.

The # template name # is clickable. Details of the report are opened by clicking the # template name #. yyyy-mm-dd hh:mm represents a submission time of the report.
2. In the case that multiple tasks are inserted into the same KR in a report, multiple pieces of progress data are inserted into “my progress” under the KR in the OKR system after submission.
3. It is found that the inserted KR has been deleted from the OKR system when the report is submitted. In this case, as shown in FIG. 4H, a prompt window “submission fails. O#N#KR#N# has been deleted, please remove them before submission” is popped up.

Second, the report is edited and it is determined whether the inserted OKR details are changed. If the inserted OKR details are changed, an original synchronized progress record is directly covered. If the inserted OKR details are not changed, no operation is required.
1. In the case that an OKR task is deleted from the event report during editing, the OKR system automatically deletes a progress record corresponding to the OKR task.
2. In the case that it is found that the inserted KR has been deleted from the OKR system when the edited report is submitted, a prompt window “submission fails, O#N#KR#N# has been deleted, please remove before submission” is popped up.

Through the above solutions according to the above embodiments, the cost of bilateral maintenance by employees can be reduced. The manager can intuitively understand, from the event report, employee engagement in the target task and a timeline of completing the target task.

It should be noted that the method according to the embodiments of the present disclosure may be performed by a single device, for example, a computer or a server. The method according to the embodiments of the present disclosure may also be applied to a distributed scenario and performed by multiple devices in cooperation with each other. In the case that the method is applied to the distributed scenario, one of the multiple devices may only perform one or more steps of the method according to the embodiments of the present disclosure, and the multiple devices interact to perform the method.

It should be noted that some embodiments according to the present disclosure are described above. Other embodiments are within the scope of the claims. In some cases, the actions or steps recorded in the claims may be performed in an order different from that in the above embodiments and the desired results can still be achieved. In addition, it is unnecessarily to perform the process illustrated in the drawings in a specific or continuous order illustrated to achieve the desired results. In some embodiments, multitasking and parallel processing are allowable or may be advantageous.

Based on a same concept, corresponding to the method for processing a workflow in combination with a task according to any one of the above embodiments, an apparatus for processing a workflow in combination with a task is further provided according to the present disclosure.

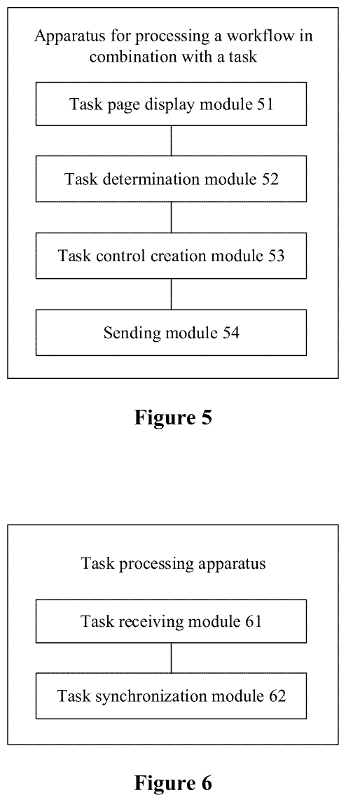

Referring to FIG. 5, the apparatus for processing a workflow in combination with a task includes a task page display module 51, a task determination module 52, a task control creation module 53, and a sending module 54.

The task page display module 51 is configured to display a task page on a content editing interface, in response to receiving a task addition instruction on the content editing interface for the workflow.

The task determination module 52 is configured to select a target task from a task displayed on the task page.

The task control creation module 53 is configured to create a task control in a preset area of the content editing interface and display the target task in the task control.

The sending module 54 is configured to send the workflow added with the target task to a target user.

In some embodiments, the task control creation module 53 is further configured to: create the task control in a content editing area of the content editing interface, where the content editing area is used for inputting at least one of a text, an image, a video, and an audio.

In some embodiments, the task control includes a task information display area and a task associated information editing area, where the task information display area is used for displaying the target task, and the task associated information editing area is used for editing content information associated with the target task.

In some embodiments, the task control creation module 53 is further configured to: display an editing result for an editing operation in the task associated information editing area, in response to receiving the editing operation in the task associated information editing area of the task control.

In some embodiments, the task determination module 52 is further configured to display at least one task corresponding to the task addition instruction on the task page; and receive at least one target task selected from the at least one task.

In some embodiments, the task determination module 52 is further configured to: determine at least one task cycle corresponding to the task addition instruction, rank the at least one task cycle in a chronological order, and display the ranked at least one task cycle on the task page, where one task cycle corresponds to one time period; receive a target task cycle selected from the at least one task cycle; and call at least one task corresponding to the target task cycle, in response to determining that there is a task within the target task cycle, and display the at least one task on the task page.

In some embodiments, the task displayed on the task page includes a first subtask and/or a second subtask, and content of the second subtask is associated with content of the first subtask.

In some embodiments, the task determination module 52 is further configured to: set the second subtask to be selectable and set the first subtask to be unselectable; and receive at least one target second subtask selected from the at least one second subtask, and determine the received at least one target second subtask as the target task.

In some embodiments, the task control creation module 53 is further configured to: determine a first identification of a second subtask corresponding to the target task, and a second identification of a first subtask corresponding to the target task; and display the first identification and the second identification in the task control.

In some embodiments, the task control creation module 53 is further configured to combine the first identification and the second identification, and display a combination of the first identification and the second identification in the task control.

In some embodiments, the task page display module 51 is further configured to display a task addition control on the content editing interface for the workflow; and in response to triggering the task addition control, generate the task addition instruction in a case of determining that an account triggering the task addition control activates a task function, and generating prompt information for activating the task function in a case of determining that the account triggering the task addition control does not activate the task function.

In some embodiments, the task control creation module 53 is further configured to generate prompt information for removing a deleted task, in response to the deleted task included in the added at least one target task.

Based on a same concept, a task processing apparatus corresponding to the task processing method according to the above embodiments is provided. As shown in FIG. 6, the task processing apparatus includes a task receiving module 61 and a task synchronization module 62.

The task receiving module 61 is configured to determine whether task associated information for a target task is added in a workflow, in response to sending the workflow added with the target task to a target user.

The task synchronization module 62 is configured to synchronize the task associated information to a task system corresponding to the target task, in a case of determining that the task associated information for the target task is added in the workflow.

In some embodiments, the task system includes: at least one first subtask component and/or multiple second subtask components, where each of the at least one first subtask component is associated with at least one of the plurality of second subtask components.

The task synchronization module 62 is further configured to: determine that at least one piece of task associated information is added for one second subtask component, where the at least one piece of task associated information is sent through at least one account; and insert the at least one piece of task associated information into a task record corresponding to the second subtask component, and mark source information corresponding to the at least one piece of task associated information in the task record.

For convenience of description, the apparatus is described by dividing the apparatus into modules or units by functions. Apparently, the functions of each module may be realized in the same one or more software and/or hardware in implementing the present disclosure.

The apparatus according to the above embodiment is used for implementing the method according to any one of the above embodiments. The apparatus has the beneficial effects described in the method embodiments, which will not be repeated herein.

Based on the same concept, corresponding to the method according to any one of the above embodiments, an electronic device is further provided according to the present disclosure. The electronic device includes a memory, a processor, and a computer program stored on the memory and executable by the processor. The processor executes the program to implement the method according to any one of the above embodiments.

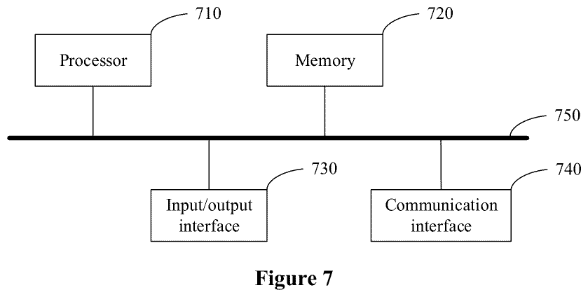

FIG. 7 is a hardware structural schematic diagram of an electronic device according to an embodiment of the present disclosure. The device includes: a processor 710, a memory 720, an input/output interface 730, a communication interface 740 and a bus 750. The processor 710, the memory 720, the input/output interface 730 and the communication interface 740 are connected to each other in communication inside through the bus 750.

The processor 710 may be implemented by using a general CPU (central processing unit), a microprocessor, an ASIC (application specific integrated circuit), or one or more integrated circuits to execute related programs, so as to implement the technical solutions according to the embodiments of the present disclosure.

The memory 720 may be implemented in a form of an ROM (read only memory), an RAM (random access memory), a static storage device, a dynamic storage device, and the like. The memory 720 may store an operating system and other application programs. In a case that the technical solutions according to the embodiments of the present disclosure are implemented through software or firmware, relevant program codes are stored in the memory 720, and called and executed by the processor 710.

The input/output interface 730 is configured to be connected to an input/output module through which information is inputted or outputted. The input/output module may be configured in a device (not shown in the figure) as a component, or connected to an external device to provide a function. The input device may include a keyboard, a mouse, a touch screen, a microphone, various sensors, and the like. The output device may include a display, a speaker, a vibrator, an indicator light, and the like.

The communication interface 740 is configured to be connected to a communication module (not shown in the Figure) to realize communication interaction between the device and other device. The communication module may realize communication in a wired manner (for example, through a USB, a network cable, and the like) or a wireless manner (for example, through a mobile network, WiFi, Bluetooth, and the like).

The bus 750 includes a path for transmitting information between various components (for example, the processor 710, the memory 720, the input/output interface 730, and the communication interface 740) of the device.

It should be noted that although the processor 710, the memory 720, the input/output interface 730, the communication interface 740 and the bus 750 are only shown in the device, the device may further include other components required by normal operation in implementation. In addition, it can be understood by those skilled in the art that the device may also include only the components required by implementing the solutions according to the embodiments of the present disclosure, rather than all the components shown in the Figure.

The electronic device according to the above embodiment is used for implementing the method for processing a workflow in combination with a task or the task processing method according to any one of the above embodiments. The device has the beneficial effects described in the embodiments of the method for processing a workflow in combination with a task and the task processing method, which will not be repeated herein.

Based on a same concept, a non-transitory computer-readable storage medium corresponding to the method according to any one of the above embodiments is further provided according to the present disclosure. The non-transient computer-readable storage medium stores computer instructions for enabling a computer to implement the method according to any one of the above embodiments.

The computer-readable medium according to this embodiment includes a persistent and non-persistent, and removable and non-removable medium. Information may be stored with any methods or technologies. The information may be computer-readable instructions, a data structure, a program module, or other data. The storage medium of the computer may include but is not limited to a phase change random-access memory (PRAM), a static random-access memory (SRAM), a dynamic random-access memory (DRAM), other types of random-access memory (RAM), read-only memory (ROM), electrically erasable programmable read-only memory (EEPROM), flash memory or other memory, compact disk read-only memory (CD-ROM), digital versatile disc (DVD), or other optical storage, cassette tape, tape disk memory or other magnetic storage, or any non-transmission medium which can be used for storing information accessible by the computer.

The computer instructions stored in the storage medium according to the above embodiment are used for enabling the computer to implement the method according to any one of the above embodiments, and have the beneficial effects described in the method embodiments, which is not repeated here.

Those skilled in the art should understand that the discussion of any one of the above embodiments is only exemplary and is not intended to imply that the scope of the present disclosure (including the claims) is limited to these examples. Based on the idea of the present disclosure, the above embodiments or the technical features in different embodiments may be combined, and the steps may be implemented in any order. There are many other changes in different aspects of the embodiments of the present disclosure as described above, which are not provided in detail for simplicity.

In addition, in order to simplify description and discussion, and in order not to make the embodiments of the present disclosure difficult to be understood, the well-known power/ground connections with integrated circuit (IC) chips and other components may or may not be shown in the drawings. In addition, the apparatus may be shown in a form of a block diagram in order to avoid making the embodiments of the present disclosure difficult to be understood, and it also takes into account a fact that the details of the embodiments of the apparatus shown in the block diagram are highly dependent on a platform on which the embodiments of the present disclosure will be implemented (that is, these details should be completely within the understanding of those skilled in the art). In a case where specific details (i.e., circuits) are described to describe exemplary embodiments of the present disclosure, it is apparent to those skilled in the art that the embodiments of the present disclosure can be implemented without these specific details or with changes in the specific details. Therefore, the descriptions should be considered illustrative rather than restrictive.

Although the present disclosure is described in combination with the specific embodiments of the present disclosure, many substitutions, modifications and variations of the embodiments are apparent to those skilled in the art based on the above description. For example, other memory architecture (i.e., a dynamic RAM (DRAM)) may be applied to the embodiments.

The embodiments of the present disclosure are intended to cover all such substitutions, modifications and variations that fall within a broad scope of the claims. Therefore, any omission, modification, equivalent replacement, improvement, and the like made within the spirit and the principle of the embodiments of the present disclosure should be included in the protection scope of the present disclosure.

1. A method for processing a workflow in combination with a task, comprising:
displaying a task page on a content editing interface, in response to receiving a task addition instruction on the content editing interface for the workflow;
selecting a target task from a task displayed on the task page;
creating a task control in a preset area of the content editing interface and displaying the target task in the task control; and
sending the workflow added with the target task to a target user.

2. The method according to claim 1, wherein the creating a task control in a preset area of the content editing interface and displaying the target task in the task control comprises:
creating the task control in a content editing area of the content editing interface, wherein the content editing area is used for inputting at least one of a text, an image, a video, and an audio.

3. The method according to claim 1, wherein the task control comprises:
a task information display area used for displaying the target task, and
a task associated information editing area used for editing content information associated with the target task.

4. The method according to claim 1, wherein after displaying the target task in the task control, the method further comprises:
displaying an editing result for an editing operation in the task associated information editing area, in response to receiving the editing operation in the task associated information editing area of the task control.

5. The method according to claim 1, wherein the selecting a target task from a task displayed on the task page comprises:
displaying at least one task corresponding to the task addition instruction on the task page; and
receiving at least one target task selected from at least one task.

6. The method according to claim 5, wherein the displaying at least one task corresponding to the task addition instruction on the task page comprises:
determining at least one task cycle corresponding to the task addition instruction, ranking the at least one task cycle in a chronological order, and displaying the ranked at least one task cycle on the task page, wherein one task cycle corresponds to one time period;
receiving a target task cycle selected from the at least one task cycle; and
calling at least one task corresponding to the target task cycle, in response to determining that there is a task within the target task cycle; and displaying the at least one task on the task page.

7. The method according to claim 1, wherein the task displayed on the task page comprises a first subtask and/or a second subtask, and content of the second subtask is associated with content of the first subtask.

8. The method according to claim 7, wherein the selecting a target task from a task displayed on the task page comprises:
setting the second subtask to be selectable and setting the first subtask to be unselectable; and
receiving at least one target second subtask selected from the at least one second subtask, and determining the received at least one target second subtask as the target task.

9. The method according to claim 7, wherein the displaying the target task in the task control comprises:
determining a first identification of a second subtask corresponding to the target task, and a second identification of a first subtask corresponding to the target task; and
displaying the first identification and the second identification in the task control.

10. The method according to claim 9, wherein the displaying the first identification and the second identification in the task control comprises:
combining the first identification and the second identification, and displaying a combination of the first identification and the second identification in the task control.

11. The method according to claim 1, wherein the displaying a task page on a content editing interface, in response to receiving a task addition instruction on the content editing interface for the workflow comprises:
displaying a task addition control on the content editing interface for the workflow; and
in response to triggering the task addition control,
generating the task addition instruction in a case of determining that an account triggering the task addition control activates a task function; and
generating prompt information for activating the task function in a case of determining that the account triggering the task addition control does not activate the task function.

12. The method according to claim 1, wherein before the sending the workflow added with the target task to a target user, the method further comprises:
generating prompt information for removing a deleted task, in response to that the added at least one target task comprises the deleted task.

13. A task processing method, comprising:
determining whether task associated information for a target task is added in a workflow, in response to sending the workflow added with the target task to a target user; and
synchronizing the task associated information to a task system corresponding to the target task, in a case of determining that the task associated information for the target task is added in the workflow.

14. The method according to claim 13, wherein the task system comprises at least one first subtask component and/or a plurality of second subtask components, and each of the at least one first subtask component is associated with at least one of the plurality of second subtask components; and
the method further comprises:
determining that at least one piece of task associated information is added for one of the plurality of second subtask components, wherein the at least one piece of task associated information is sent through at least one account; and
inserting the at least one piece of task associated information into a task record corresponding to the one of the plurality of second subtask components, and marking source information corresponding to the at least one piece of task associated information in the task record.

15. An electronic device, comprising:
a memory;
a processor; and
a computer program stored on the memory and executable by the processor,
wherein the processor executes the computer program to:
display a task page on a content editing interface, in response to receiving a task addition instruction on the content editing interface for the workflow; select a target task from a task displayed on the task page; create a task control in a preset area of the content editing interface and displaying the target task in the task control; and send the workflow added with the target task to a target user; or
determine whether task associated information for a target task is added in a workflow, in response to sending the workflow added with the target task to a target user; and synchronize the task associated information to a task system corresponding to the target task, in a case of determining that the task associated information for the target task is added in the workflow.

16. The electronic device according to claim 15, wherein the task control is created in a preset area of the content editing interface by:
creating the task control in a content editing area of the content editing interface, wherein the content editing area is used for inputting at least one of a text, an image, a video, and an audio.

17. The electronic device according to claim 15, wherein the task control comprises:
a task information display area used for displaying the target task, and
a task associated information editing area used for editing content information associated with the target task.

18. The electronic device according to claim 15, wherein after displaying the target task in the task control, the processor executes the computer program to:
display an editing result for an editing operation in the task associated information editing area, in response to receiving the editing operation in the task associated information editing area of the task control.

19. The electronic device according to claim 15, wherein the processor executes the computer program to:
display at least one task corresponding to the task addition instruction on the task page; and
receive at least one target task selected from at least one task.

20. A non-transitory computer-readable storage medium storing computer instructions, wherein the computer instructions, when executed by a computer, cause the computer to:
display a task page on a content editing interface, in response to receiving a task addition instruction on the content editing interface for the workflow; select a target task from a task displayed on the task page; create a task control in a preset area of the content editing interface and displaying the target task in the task control; and send the workflow added with the target task to a target user; or
determine whether task associated information for a target task is added in a workflow, in response to sending the workflow added with the target task to a target user; and synchronize the task associated information to a task system corresponding to the target task, in a case of determining that the task associated information for the target task is added in the workflow.
